(19) United States
(12) Patent Application Publication
(10) Pub. No.: US 2018/0072167 A1
(43) Pub. Date: Mar. 15, 2018

(54) FAST CHARGING SYSTEM FOR ELECTRIC VEHICLES

(71) Applicant: EFACEC ELECTRIC MOBILITY, S.A., Moreira da Maia (PT)

(72) Inventors: Pedro Nuno MARCOS MOREIRA DA SILVA, Moreira da Maia (PT); Vitor Alexandre MARTINS FERREIRA, Moreira da Maia (PT); Lino Joao DA SILVA PAUPERIO PEREIRA, Moreira da Maia (PT); Domingos Horacio CARVALHO GQNCALVES, Moreira da Maia (PT)

(21) Appl. No.: 15/560,335

(22) PCT Filed: May 12, 2016
(86) PCT No.: PCT/IB2016/052726

§ 371 Date: Sep. 21, 2017

(30) Foreign Application Priority Data
May 14, 2015 (PT) 108474

(51) Int. Cl. B60L 11/18

(52) U.S. Cl. CPC B60L 11/1809

(57) ABSTRACT

The present application solves the problem of limiting the input power of a fast charging system for electric vehicles to a value that is lower than the output power during the fast charging of electric vehicles. A fast charging system for electric vehicles (100) is disclosed, which comprises a battery (103), a stage of input power electronics (101), and a stage of output power electronics (102). The system supplies power to the charging circuit (111), this power being higher than the input power obtained from the public low-voltage power supply network (110). This solution is used for charging electric vehicles such as cars, buses or any other vehicle equipped with an electric energy storage system rechargeable by means of an external connection.

### TECHNICAL FIELD

The present application relates to a fast charging system for electric vehicles.

### BACKGROUND

In the present days there is a growing use of electric vehicles charging systems, resulting on an increasing need for widely distributed stations accessible to the public.

Several standards have been established between manufacturers of electric cars, suppliers of charging structures as well as regional governments, with the aim to promote and provide networks of public charging stations for electric vehicles. IEC 61851-23 presents the requirements for the conductive charge of electric vehicles with direct current, wherein an alternating or direct current with a voltage input of up to 1000 V of alternating current and up to 1500 V of direct current is used as input for the charger according to IEC 60038. This standard is widely recognised and used by persons skilled in the art. It also provides the general requirements for the control communication between a direct current charging station and an electric vehicle.

Typically, the power output observed in a fast charging system for electric vehicles presents a pace in which the maximum power is reached during a certain time and subsequently decays to zero.

Said maximum power is often high, typically above 20 kW, thus entailing some requirements on input, such as for example the supply of an input power that is sufficient to provide maximum power by means of an installation tailored to that need.

The low-voltage network has a nominal voltage value dependent on the geographic location, this way in Europe there is usually a voltage of 400 V, 50 Hz, in the case of three-phase supplies, and 230 V, in the case of single-phase supplies. In other geographic locations the voltage and frequency may be different. The power of the facility has an investment cost which increases in proportion to the power, the higher the power, the greater the cost, and has a cost of availability, the power rate, which also rises with the subscribed demand.

These constraints often cause that, in order to limit the input power, the power supplied is divided and shared. This way, when a fast charging system of the prior art has, for example, 50 kW available from the network and has two electric vehicles being charged, the network provides 25 kW for each one of the vehicles.

At present, in the prior art, in general there are solutions which, while enabling the charge of electric vehicles, they require a constant management of the power supply. Known solutions require a supply equal to the output power, and can be seen as systems that limit the charging power.

The U.S. 2008/0067974 document discloses a charging system for electric cars, which includes a supply system of electric power network AC and an electric car charging equipment that includes a battery and a control module. Conceptually, the architecture of the charging system described herein is different from the one now presented, not being described therein how said configuration allows the control of the input power that enables that the desired value for the output power be reached for the output power of said charging system.

The U.S. 2014/0167697 document discloses an installation for charging an electric battery that is integrated in the vehicle's control system controlled by its on-board computer. In this particular case, the charging power is determined in relation to the charging voltage and current required by the computer. The charging power is guaranteed by means of ancillary energy sources, used in parallel with the main energy source.

### GENERAL DESCRIPTION

The present application solves the problem of limiting the input power of a fast charging system for electric vehicles to a value that is lower than the output power during the fast charging of electric vehicles.

A fast charging system for electric vehicles is disclosed, which comprises:
a stage of input power electronics;
a stage of output power electronics; and
a battery,
   wherein the stage of input power electronics is powered by a low-voltage network, and the battery (103) is interposed between the stage of input power electronics (101) and the stage of output power electronics (102).

Since the present system comprises an interposed battery, it thus becomes possible to limit the input power to a given Pᵢₙ value, for example, the power supplied by the low-voltage network, being the remaining power supplied by the battery when the output power Pₒᵤₜ is greater then Pᵢₙ. This battery is charged or discharges in accordance with the requirements and therefore ensures the limitation of the power needed at the input.

In the present system, the stage of input power electronics is unidirectional, in the direction of the charge. This includes the conversion of the input alternating voltage into controlled direct voltage so as to charge and keep the battery charged, as well as to feed the output stage. It also ensures the galvanic isolation between the network and the intermediate stage where the battery and the output stage are connected. In addition, it is configured to transmit power, usually only in the single direction of the charge. Optionally, this stage is configured to transmit power bidirectionally, thus allowing the eventual supply of accumulated power to the network.

The stage of output power electronics is configured to transmit power in the single direction of the charge. This includes converting the direct voltage of the intermediate stage into the voltage and current required to charge the vehicle's battery. Moreover, this element is responsible for automatically adapting the voltage and current that the charge requires. This adaptation takes place by means of communication between the charger and the vehicle, according to one of several existing standards, such as for example any of the systems described in IEC 61851-23.

The battery is preferably of the type lithium-ion. Optionally, the battery may be of other types, for example, the lead-acid type. This has the capacity to provide, at least once, the differential of power during the time in which the output power is greater than Pᵢₙ. The battery capacity in kWh is at least half of the capacity of the battery of the vehicles to be charged, which allows to ensure a maximum output power Pₘₐₓ of at least twice the input power. Typically, the input power is 20 kW, the output power is 50 kW for electric vehicles with batteries having a nominal voltage between 200 V and 400 V, but other values are possible to be used.

Since the power supply falls to zero after reaching the maximum power from the moment that Pₒᵤₜ becomes lower than Pᵢₙ, which in practice it usually occurs after approximately 10 to 20 minutes depending on the capacity of the vehicle's battery to be charged, the initial state of charge and the output power of the charger, the battery of this system will be able to be charged with the excess available in the input stage.

At the end of charging process of an electric vehicle, there is still the possibility that the battery may have received all the energy provided, the system being readily available to charge another vehicle, or else reach this stage after a short period of time.

The main advantage of this solution is that the absorbed power from the network is limited to the Pᵢₙ, not being necessary an installation tailored for Pₘₐₓ. The network consumption is also levelled since there are no variations and can always be made to the power Pᵢₙ. When the battery is in a state of total charge and there are no electric vehicles to be charged, there is no consumption to the network.

This solution is used for charging electric vehicles such as cars, buses or any other vehicle equipped with an electric energy storage system rechargeable by means of an external connection.

### BRIEF DESCRIPTION OF THE DRAWINGS

For an easier understanding of the present application there are attached figures, which represent preferred embodiments that, however are not intended to limit the art disclosed herein.

FIG. 1 illustrates an embodiment of the fast charging system for electric vehicles, in which the reference numbers represent:

100—a fast charging system for electric vehicles;

101—a stage of input power electronics;

102—a stage of output power electronics;

103—a battery;

110—public low-voltage power supply network; and

111—charging circuit.

FIG. 2 illustrates an embodiment of the fast charging system for electric vehicles, wherein the stage of input power electronics (101) only charges the battery (103).

FIG. 3 illustrates an embodiment of a fast charging system for electric vehicles, wherein the stage of input power electronics (101) and the battery (103) charge the charging circuit (111) by means of the stage of output power electronics (102).

FIG. 4 illustrates an embodiment of a fast charging system for electric vehicles, wherein the stage of input power electronics (101) charges both the battery (103) and the charging circuit (111) by means of the stage of output power electronics (102).

FIG. 5 illustrates the typical curve of the required power to charge an electric vehicle, wherein the horizontal axis represents time, the vertical axis represents de output power Pₒᵤₜ, and the reference numbers represent:

501—energy supplied by the battery; and

502—energy absorbed by the battery.

### DESCRIPTION OF EMBODIMENTS

With reference to the figures, some embodiments are now described in more detail, which however do not intend to limit the scope of the present application.

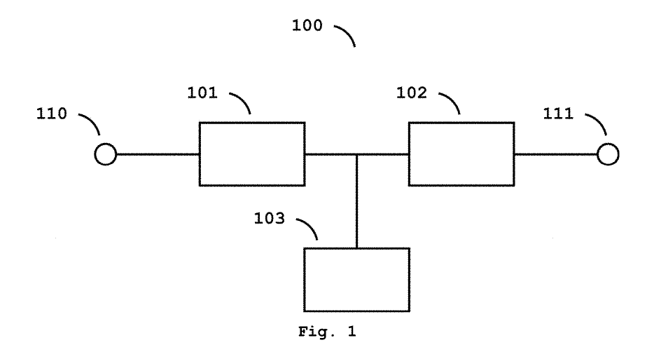

FIG. 1 illustrates an embodiment of the fast charging system for electric vehicles (100), wherein the essential elements thereof are observed. The public low-voltage power supply network (110) provides power to a stage of input power electronics (101) and the charging circuit (111) is supplied by the stage of output power electronics (102). There is a central node in the system, to which a lithium-ion battery (103) is attached.

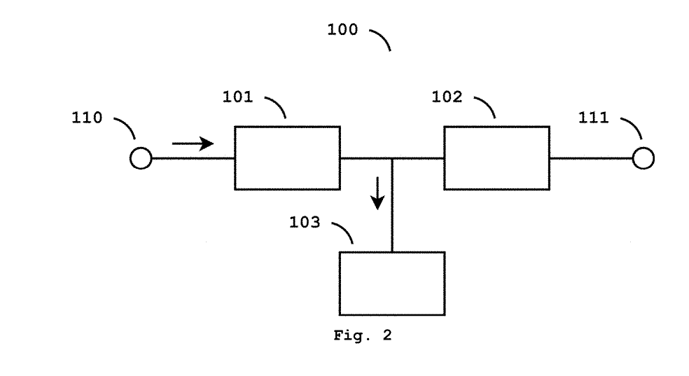

FIGS. 2 to 4 illustrate the energy flows in an embodiment of a fast charging system for electric vehicles, varying these according to the electric conditions of the charging circuit (111).

In FIG. 2 the charging circuit (111) has no electric vehicle charging, therefore the stage of input power electronics (101) only charges the battery (103).

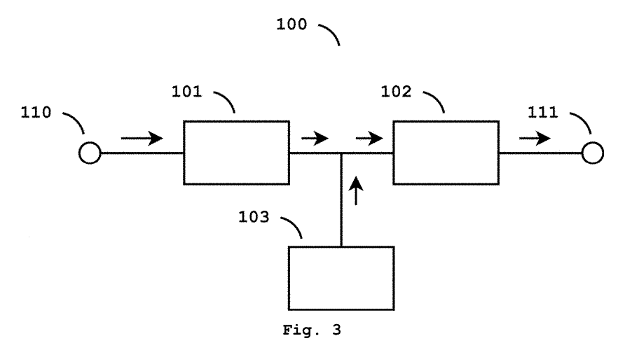

In FIG. 3 the charging circuit (111) has at least one electric vehicle charging, therefore both the stage of input power electronics (101) and the battery (103) charge the charging circuit (111) by means of the stage of output power electronics (102).

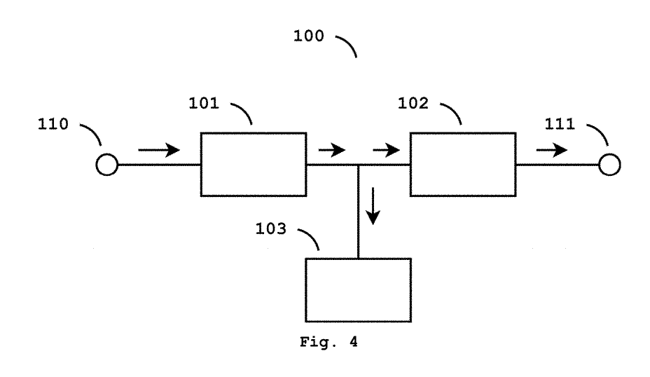

In FIG. 4 the charging circuit (111) has at least one electric vehicle charging as in FIG. 3, however this figure illustrates a state in which the output power is already lower than the power provided by the public low-voltage power supply network (110). In this case, the stage of input power electronics (101) charges both the battery (103) and the charging circuit (111) by means of the stage of output power electronics (102).

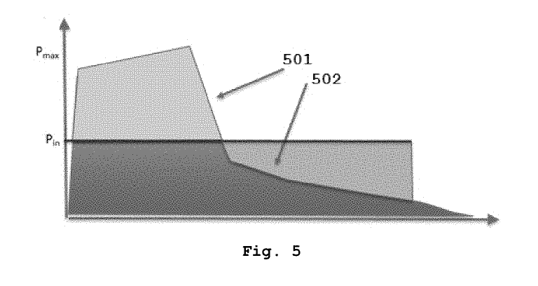

FIG. 5 illustrates the typical curve of the required power to charge an electric vehicle, wherein the horizontal axis represents time and the vertical axis represents the output power Pₒᵤₜ. In this figure regions in the graph can be observed that relate to FIGS. 3 and 4. The energy provided by the battery (501), as illustrated in FIG. 3, relates to the region where the output power is higher than the input power provided by the public low-voltage power supply network. The energy absorbed by the battery (502), as illustrated in FIG. 4, relates to the region where the output power is lower than the input provided by the public low-voltage power supply network.

Of course, the present disclosure is not, in any way, restricted to the embodiments presented herein and a person of ordinary skill in the art can predict many possibilities for modification thereof without departing from the general idea as defined in the claims. The embodiments described above can obviously be combined with each other. The following claims further define preferred embodiments.

1. A fast charging system for electric vehicles, comprising:
a stage of input power electronics;
a stage of output power electronics;
a battery,
wherein the stage of input power electronics is powered by a low-voltage network, and the battery is interposed, specifically, between the stage of input power electronics and the stage of output power electronics.

2. The system according to claim 1, wherein the stage of input power electronics is configured to receive 20 kW, and the stage of output power electronics is configured to supply an output power of 50 kW to the battery with a nominal voltage between 200 V and 400 V.

3. The system according to claim 1, wherein the stage of input power electronics is unidirectional, in the direction of the charge.

4. The system according to claim 1, wherein the stage of input power electronics is bidirectional.

5. The system according to claim 1, wherein the stage of output power electronics is unidirectional, in the direction of the charge.

6. The system according to claim 1, wherein the battery is a lithium-ion battery.

7. The system according to claim 1, wherein the battery is a lead-acid battery.
